(19) United States
(12) Patent Application Publication
(10) Pub. No.: US 2025/0012332 A1
(43) Pub. Date: Jan. 9, 2025

(54) DISC BRAKE SYSTEM AND CONTROLLING METHOD THEREOF

(71) Applicant: HL MANDO CORPORATION, Pyeongtaek-si (KR)

(72) Inventor: Hatem SHAHIN, Pfaffenhofen (DE)

(21) Appl. No.: 18/430,222

(22) Filed: Feb. 1, 2024

(30) Foreign Application Priority Data
Jul. 7, 2023 (DE) 10 2023 206 493.6

(51) Int. Cl. F16D 63/00; B60T 8/171; B60T 8/172; B60T 13/16; B60T 13/66; F16D 55/226; F16D 55/228; F16D 65/18; F16D 121/04; F16D 125/02; F16D 125/08

(52) U.S. Cl. CPC F16D 63/004; B60T 8/171; B60T 8/172; B60T 13/168; B60T 13/662; F16D 55/226; F16D 55/228; F16D 65/18; B60T 2201/03; B60T 2220/04; F16D 2121/04; F16D 2125/023; F16D 2125/08

(57) ABSTRACT

Disclosed herein is a disc brake system. The disc brake system according to the present embodiment includes a main braking part configured to slide and move a pair of main pads respectively disposed on both side surfaces of a disc in a direction of an axis of the disc and generate a main braking force by friction between the both side surfaces of the disc and the main pads, an auxiliary braking part configured to slide and move an auxiliary pad disposed at a side of an outer circumferential surface of the disc in a radial direction of the disc and generate an auxiliary braking force by friction between the outer circumferential surface of the disc and the auxiliary pad, and a controller configured to activate the main braking part in response to an input value generated based on a pedal force of a brake pedal measured by a sensor.

### CROSS-REFERENCE TO RELATED APPLICATION

This application claims priority from Germany Patent Application No. 102023206493.6, filed on Jul. 7, 2023, which is hereby incorporated by reference for all purposes as if fully set forth herein.

### BACKGROUND

### 1. Field

Embodiments of the present disclosure relate to a disc brake system and a controlling method thereof, and more particularly, to a disc brake system capable of providing a stronger braking force by increasing a friction area in an emergency braking situation and a controlling method thereof.

### 2. Description of the Related Art

Generally, braking of a traveling vehicle is performed by providing a braking force generated by a driver, who determines a braking situation and pushes a brake pedal, to a disc and the like rotating together with a wheel of the vehicle. However, when an emergency braking situation occurs such as when a preceding vehicle suddenly stops or a hazardous object suddenly appears, even when a driver determines the braking situation and pushes a brake pedal, a problem is that a collision with the preceding vehicle or the hazardous object frequently occurs due to a braking distance.

Recently, to solve this problem, brake assist systems (BASs) are being used which can reduce a braking distance by autonomously determining an emergency braking situation such as sudden braking and instantly increasing a braking force or by increasing the braking force according to a driver's manipulation on an operation switch.

However, a brake assist system, which increases a braking force according to a driver's manipulation on an operation switch when an emergency braking situation occurs, has low effectiveness, and since a brake assist system, which autonomously determines an emergency braking situation and instantly increases a braking force, does nothing but increase a frictional force by increasing a pressure provided to brake pads pressing both sides of a disc for braking, there is a problem that is not sufficient to prevent a collision due to a braking distance.

### SUMMARY

Therefore, it is an aspect of the present disclosure to provide a disc brake system capable of providing a stronger braking force by increasing a friction area in an emergency braking situation and a controlling method thereof.

Additional aspects of the disclosure will be set forth in part in the description which follows and, in part, will be obvious from the description, or may be learned by practice of the disclosure.

In accordance with one aspect of the present disclosure, a disc brake system includes a main braking part configured to slide and move a pair of main pads respectively disposed on both side surfaces of a disc in a direction of an axis of the disc and generate a main braking force by friction between the both side surfaces of the disc and the main pads, an auxiliary braking part configured to slide and move an auxiliary pad disposed at a side of an outer circumferential surface of the disc in a radial direction of the disc and generate an auxiliary braking force by friction between the outer circumferential surface of the disc and the auxiliary pad, and a controller configured to activate the main braking part in response to an input value generated based on a pedal force of a brake pedal measured by a sensor, and the controller activates or deactivates the auxiliary braking part by comparing the input value and a preset threshold value.

When the input value is greater than or equal to the threshold value, the controller may activate the auxiliary braking part and then activate the main braking part.

When the input value is less than the threshold value, the controller may maintain deactivation of the auxiliary braking part and activate the main braking part.

The main braking part may include a housing including a cylinder provided on one side with a piston moving any one of the main pads forward and backward by a supplied hydraulic pressure, a finger provided on the other side and configured to move the remaining one of the main pads forward and backward according to a forward and backward movement of the piston, and a bridge provided between the cylinder and the finger, and a main actuator configured to provide the supplied hydraulic pressure to the cylinder.

The main braking part may further include a carrier fixedly in which the main pads are installed to be movable forward and backward and the housing is installed to be slidable to be fixedly installed in a vehicle body.

The main braking part may further include a sealing member provided between the piston and the cylinder to return the piston.

The main actuator may include a hydraulic circuit configured to provide the supplied hydraulic pressure corresponding to the input value to the cylinder.

The main actuator may include an electric motor and a power converter configured to convert a rotational motion of the electric motor into a linear motion and provide the supplied hydraulic pressure corresponding to the input value to the cylinder.

The power converter may include a spindle configured to rotate by the electric motor and a spindle nut provided inside the piston and configured to convert a rotational motion of the spindle into a linear motion.

The auxiliary braking part may include the auxiliary pad provided on the bridge and an auxiliary actuator configured to move the housing forward and backward in the radial direction of the disc.

The main braking part may include a housing including cylinders provided on both sides with pistons moving the main pads forward and backward respectively by a supplied hydraulic pressure, and a bridge provided between the cylinders, and a main actuator configured to provide the supplied hydraulic pressure to each of the cylinders.

The main braking part may further include a knuckle in which the main pads are installed to be movable forward and backward to be fixedly installed in a vehicle body.

The main braking part may further include sealing members provided between the pistons and the cylinders and configured to return the pistons.

The main actuator may include hydraulic circuits configured to provide the supplied hydraulic pressure corresponding to the input value to the cylinders.

The main actuator may include an electric motor and a power converter configured to convert a rotational motion of the electric motor into a linear motion and provide the supplied hydraulic pressure corresponding to the input value to the cylinders.

The power converter may include a spindle configured to rotate by the electric motor and a spindle nut provided inside each of the pistons and configured to convert a rotational motion of the spindle into a linear motion.

The auxiliary braking part may include the auxiliary pad provided on the bridge and an auxiliary actuator configured to move the housing forward and backward in the radial direction of the disc.

In accordance with another aspect of the present disclosure, there is provided a method of controlling a disc brake system, and the disc brake system includes a main braking part configured to slide and move a pair of main pads respectively disposed on both side surfaces of a disc in a direction of an axis of the disc and generate a main braking force by friction between the both side surfaces of the disc and the main pads, an auxiliary braking part configured to slide and move an auxiliary pad disposed at a side of an outer circumferential surface of the disc in a radial direction of the disc and generate an auxiliary braking force by friction between the outer circumferential surface of the disc and the auxiliary pad, and a controller configured to activate the main braking part in response to an input value generated based on a pedal force of a brake pedal measured by a sensor, and the controller activates or deactivates the auxiliary braking part by comparing the input value and a preset threshold value.

When the input value is greater than or equal to the threshold value, the controller may activate the auxiliary braking part and then activate the main braking part.

When the input value is less than the threshold value, the controller may maintain deactivation of the auxiliary braking part and activate the main braking part.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram illustrating a configuration of a disc brake system in accordance with one embodiment of the present disclosure;

FIG. 2 is a cross-sectional view illustrating a state in which a main braking force of the disc brake system provided as a floating type in accordance with one embodiment of the present disclosure is provided;

FIG. 3 is a cross-sectional view illustrating a braking state in which the main braking force and an auxiliary braking force of the disc brake system provided as the floating type in accordance with one embodiment of the present disclosure are provided;

FIG. 4 is a cross-sectional view illustrating a state in which a main braking force of the disc brake system provided as a fixed type in accordance with one embodiment of the present disclosure is provided;

FIG. 5 is a cross-sectional view illustrating a braking state in which the main braking force and an auxiliary braking force of the disc brake system provided as the fixed type in accordance with one embodiment of the present disclosure are provided; and

FIG. 6 is a flowchart illustrating an algorithm of a controlling method of the disc brake system in accordance with one embodiment of the present disclosure.

### DETAILED DESCRIPTION

Hereinafter, embodiments of the present disclosure will be described in detail with reference to the accompanying drawings. The following embodiment is provided to fully convey the spirit of the present disclosure to a person having ordinary skill in the art to which the present disclosure belongs. The present disclosure is not limited to the embodiment shown herein but may be embodied in other forms. The drawings may omit the illustration of parts not related to the description in order to clarify the present invention, and slightly exaggerate the size of the components to help understanding.

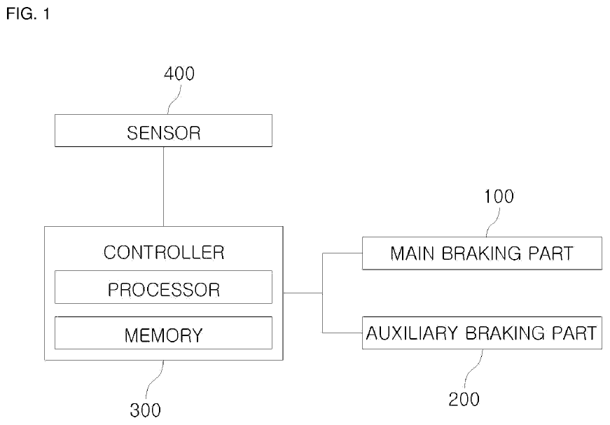

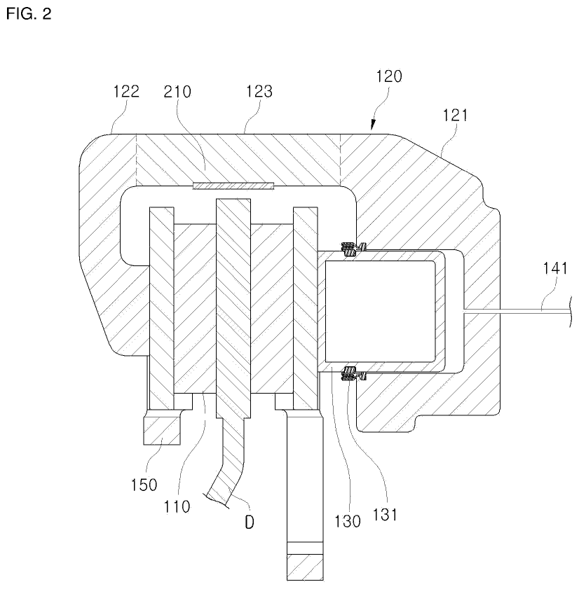

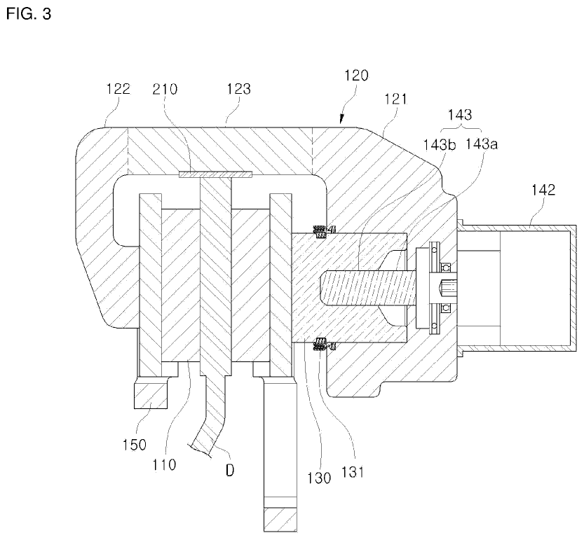

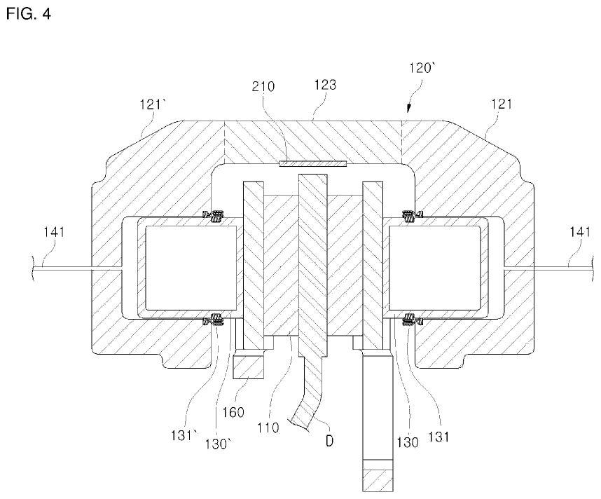

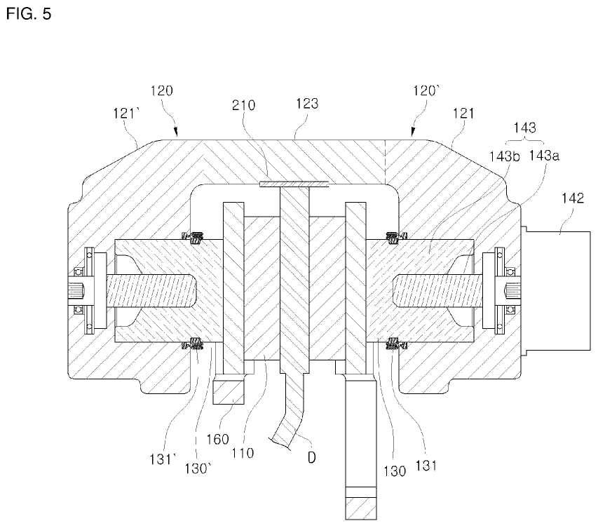

FIG. 1 is a block diagram illustrating a configuration of a disc brake system in accordance with one embodiment of the present disclosure. In addition, FIGS. 2 and 3 are cross-sectional views illustrating a state in which a main braking force of the disc brake system provided as a floating type in accordance with one embodiment of the present disclosure is provided and a braking state in which the main braking force and an auxiliary braking force of the disc brake system provided as the floating type in accordance with one embodiment of the present disclosure are provided, respectively. In addition, FIGS. 4 and 5 are cross-sectional views illustrating a state in which a main braking force of the disc brake system provided as a fixed type in accordance with one embodiment of the present disclosure is provided and a braking state in which the main braking force and an auxiliary braking force of the disc brake system provided as the fixed type in accordance with one embodiment of the present disclosure are provided, respectively.

Referring to FIGS. 1 to 5, the disc brake system according to one embodiment of the present disclosure includes a main braking part 100, an auxiliary braking part 200, a controller 300, and a sensor 400.

The main braking part 100 slides and moves a pair of main pads 110 respectively disposed on both side surfaces of a disc D rotating together with a wheel of a vehicle in a direction of an axis of the disc D, and generates a main braking force by friction between the both side surfaces of the disc D and the main pads 110.

To this end, the main braking part 100 may include, as illustrated in FIGS. 2 and 3, a housing 120 including a cylinder 121 provided on one side with a piston 130 moving any one of the main pads 110 forward and backward by a supplied hydraulic pressure, a finger 122 provided on the other side and configured to move the remaining one of the main pads 110 forward and backward according to a forward and backward movement of the piston 130, and a bridge 123 provided between the cylinder 121 and the finger 122, and a main actuator 140 configured to provide the supplied hydraulic pressure to the cylinder 121. In addition, the main braking part 100 may further include a carrier 150 in which the pair of main pads 110 are installed to be movable forward and backward and the housing 120 is installed to be slidable to be fixedly installed in a vehicle body. In addition, the main braking part 100 may further include a sealing member provided between the piston 130 and the cylinder 121 and configured to return the piston 130.

The main actuator 140 may include, as illustrated in FIG. 2, a hydraulic circuit 141 configured to provide the supplied hydraulic pressure corresponding to an input value generated based on a pedal force of a brake pedal (not shown) measured by the sensor 400 to the cylinder 121.

The main actuator 140 may include, as illustrated in FIG. 3, a power converter 143 configured to convert a rotational motion of an electric motor 142 into a linear motion and provide a supplied hydraulic pressure corresponding to an input value to the cylinder 121. As an example, the power converter 143 may include a spindle 143a configured to rotate by the electric motor 142 and a spindle nut 143b provided inside the piston 130 and configured to convert a rotational motion of the spindle 143a into a linear motion.

Meanwhile, the main braking part 100 may include, as illustrated in FIGS. 4 and 5, a housing 120′ including cylinders 121 and 121′ provided on both sides with pistons 130 and 130′ respectively moving main pads 110 forward and backward by a supplied hydraulic pressure, a bridge 123 provided between the cylinders 121 and 121′, and a main actuator 140 configured to provide the supplied hydraulic pressure to each of the cylinders 121 and 121′. In addition, the main braking part 100 may include a knuckle 160 in which the main pads 110 are installed to be movable to be fixedly installed in a vehicle body forward and backward. In addition, as described above, the main braking part 100 may further include sealing members 131 and 131′ provided respectively between the piston 130 and the cylinder 121 and between the piston 130′ and the cylinder 121′, and configured to return the pistons 130 and 130′.

The main actuator 140 may include, as illustrated in FIG. 4, hydraulic circuits 141 configured to provide a supplied hydraulic pressure corresponding to an input value generated based on a pedal force of a brake pedal (not shown) measured by the sensor 400 to each of the cylinders 121 and 121″.

The main actuator 140 may include, as illustrated in FIG. 5, a power converter 143 configured to convert a rotational motion of the electric motor 142 into a linear motion and provide a supplied hydraulic pressure corresponding to an input value to the cylinder 121. As an example, the power converter 143 may include a spindle 143a configured to rotate by an electric motor 142 and a spindle nut 143b provided inside the piston 130 and configured to convert a rotational motion of the spindle 143a into a linear motion. In addition, although not shown, the main actuator 140 may be provided in a way in which the hydraulic circuits 141 configured to provide the supplied hydraulic pressure corresponding to the input value to each of the cylinders 121 and 121′ are coupled with the power converter 143 configured to convert the rotational motion of the electric motor 142 into the linear motion and provide the supplied hydraulic pressure corresponding to the input value to the cylinder 121.

The auxiliary braking part 200 slides and moves an auxiliary pad 210 disposed on a side of an outer circumferential surface of the disc D in a radial direction of the disc D, and generates an auxiliary braking force by friction between the outer circumferential surface of the disc D and the auxiliary pad 210.

To this end, the auxiliary braking part 200 may include the auxiliary pad 210 provided on an inner side of the bridge 123, as illustrated in FIGS. 2 to 5, and an auxiliary actuator (not shown) configured to move the housings 120 and 120′ forward and backward in the radial direction of the disc D. Herein, the auxiliary actuator may be applied as a device capable of moving the housings 120 and 120′ forward and backward in the radial direction of the disc D from a vehicle body in various ways including a hydraulic way, an electromechanical way, or the like. As an example, by forming a distance of 1 to 2.2 mm between the auxiliary pad 210 with a thickness of 0.4 to 0.6 mm and the outer circumferential surface of the disc D, the disc brake system according to one embodiment of the present disclosure may provide a main braking force and an auxiliary braking force together in an emergency braking situation such as sudden braking, and thus increase a friction area between the pad and the disc D and reduce a braking distance. Also, the auxiliary pad 210 can be made different materials the main pads 110. Since the auxiliary pad 210 have the maximal possible coefficient of friction in relation with disc D made by cast iron, damping behavior is not important in the case of emergency compared with the main pads 110.

The controller 300 includes a processor 310 and a memory 320. Herein, the processor 310 may control an overall operation of the disc brake system according to one embodiment of the present disclosure. In addition, the memory 320 may store a program for processing or control of the processor 310 and various data including a threshold value for operating the disc brake system according to one embodiment of the present disclosure, and the like. As an example, the memory 320 may include not only volatile memories such as an S-RAM and a D-RAM but also non-volatile memories such as a flash memory, a read only memory (ROM), and an erasable programmable read only memory (EPROM).

The controller 300 may activate the main braking part 100 in response to an input value generated based on a pedal force of a brake pedal measured by the sensor 400 and activate or deactivate the auxiliary braking part 200 by comparing the input value and a preset threshold value. As an example, the threshold value may be set to a pressure of 120 bar. More specifically, when the input value is greater than or equal to the threshold value, the controller 300 may activate the auxiliary braking part 200 and then activate the main braking part 100. In addition, when the input value is less than the threshold value, the controller 300 may maintain deactivation of the auxiliary braking part 200 and activate the main braking part 100.

As described above, the sensor 400 may be provided to be electrically connected to the controller 300 as a tool for generating the input value based on the pedal force of the brake pedal. In addition, the sensor 400 may be provided at a side of the brake pedal or provided in the hydraulic circuit 141 between the brake pedal and the main braking part 100.

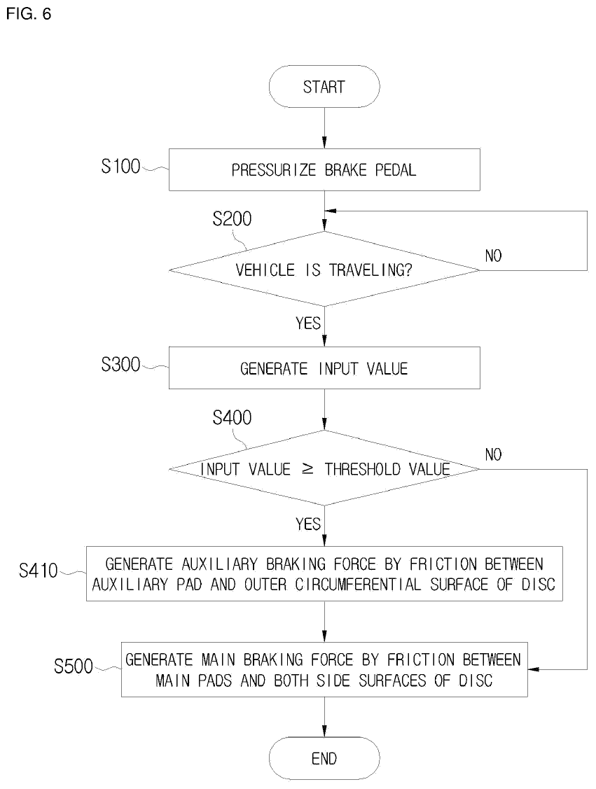

Meanwhile, FIG. 6 is a flowchart illustrating an algorithm of a controlling method of the disc brake system in accordance with one embodiment of the present disclosure.

Referring to FIGS. 1 to 6, in the controlling method of the disc brake system according to one embodiment of the present disclosure, when a driver pressurizes a brake pedal to stop a vehicle (100), the controller 300 determines whether or not the vehicle is traveling (200) and, when it is determined that the vehicle is traveling, generates an input value corresponding to a pedal force of the brake pedal detected by the sensor 400 (300). Herein, the input value may be directly generated by the sensor 400.

Next, the controller 300 compares the input value and a preset threshold value (400) and determines an emergency braking situation. More specifically, the controller 300 determines a normal braking situation when the input value is less than the threshold value, and determines the emergency braking situation when the input value is greater than or equal to the threshold value.

Meanwhile, when the input value and the preset threshold value are compared (400) and it is determined to be the normal braking situation, the controller 300 activates the main braking part 100 configured as above, generates a main braking force by friction between the main pads 110 and both side surfaces of the disc D (500), and thus stops the vehicle.

In addition, when the input value and the preset threshold value are compared (400) and it is determined to be the emergency braking situation, the controller 300 generates an auxiliary braking force by friction between the auxiliary pad 210 and the outer circumferential surface of the disc D by activating the auxiliary braking part 200 configured as above (410), and generates the main braking force by friction between the main pads 110 and both side surfaces of the disc D by activating the main braking part (500), and thus stops the vehicle.

Accordingly, the disc brake system according to the present embodiment may provide a stronger braking force by increasing a friction area in the emergency braking situation, reduce a braking distance, and thus effectively prevent a collision accident due to the braking distance.

Although specific embodiments of a disc brake system of the present disclosure and a controlling method thereof have been described, it is clear that various modifications could be made without departing from the scope of the present disclosure.

A disc brake system according to the present embodiment and a controlling method thereof can provide a stronger braking force by increasing a friction area in an emergency braking situation, reduce a braking distance, and thus effectively prevent a collision accident due to the braking distance.

Therefore, the scope of the present disclosure is not limited to the described embodiments and should be defined by equivalents of the appended claims as well as the scope of the appended claims.

That is, it should be understood that the above-described embodiments are illustrative in all aspects and not restrictive, the scope of the present disclosure is indicated by the appended claims described below rather than the detailed description, and it should be construed that the meaning and scope of the appended claims and all changes or modifications derived from equivalent concepts thereof are included in the scope of the present disclosure.

What is claimed is:

1. A disc brake system comprising:
a main braking part configured to slide and move a pair of main pads respectively disposed on both side surfaces of a disc in a direction of an axis of the disc and generate a main braking force by friction between the both side surfaces of the disc and the main pads;
an auxiliary braking part configured to slide and move an auxiliary pad disposed at a side of an outer circumferential surface of the disc in a radial direction of the disc and generate an auxiliary braking force by friction between the outer circumferential surface of the disc and the auxiliary pad; and
a controller configured to activate the main braking part in response to an input value generated based on a pedal force of a brake pedal measured by a sensor,
wherein the controller activates or deactivates the auxiliary braking part by comparing the input value and a preset threshold value.

2. The disc brake system of claim 1, wherein, based on the input value greater than or equal to the threshold value, the controller activates the auxiliary braking part and then activates the main braking part.

3. The disc brake system of claim 1, wherein, based on the input value less than the threshold value, the controller maintains deactivation of the auxiliary braking part and activates the main braking part.

4. The disc brake system of claim 1, wherein the main braking part includes:
a housing including a cylinder provided on one side with a piston moving any one of the main pads forward and backward by a supplied hydraulic pressure, a finger provided on the other side and configured to move the remaining one of the main pads forward and backward according to a forward and backward movement of the piston, and a bridge provided between the cylinder and the finger; and
a main actuator configured to provide the supplied hydraulic pressure to the cylinder.

5. The disc brake system of claim 4, wherein the main braking part further includes a carrier in which the main pads are installed to be movable forward and backward and the housing is installed to be slidable to be fixedly installed in a vehicle body.

6. The disc brake system of claim 4, wherein the main braking part further includes a sealing member provided between the piston and the cylinder to return the piston.

7. The disc brake system of claim 4, wherein the main actuator includes a hydraulic circuit configured to provide the supplied hydraulic pressure corresponding to the input value to the cylinder.

8. The disc brake system of claim 4, wherein the main actuator includes:
an electric motor; and
a power converter configured to convert a rotational motion of the electric motor into a linear motion and provide the supplied hydraulic pressure corresponding to the input value to the cylinder.

9. The disc brake system of claim 8, wherein the power converter includes:
a spindle configured to rotate by the electric motor; and
a spindle nut provided inside the piston and configured to convert a rotational motion of the spindle into a linear motion.

10. The disc brake system of claim 4, wherein the auxiliary braking part includes:
the auxiliary pad provided on the bridge; and
an auxiliary actuator configured to move the housing forward and backward in the radial direction of the disc.

11. The disc brake system of claim 1, wherein the main braking part includes:
a housing including cylinders provided on both sides with pistons moving the main pads forward and backward respectively by a supplied hydraulic pressure, and a bridge provided between the cylinders; and
a main actuator configured to provide the supplied hydraulic pressure to each of the cylinders.

12. The disc brake system of claim 11, wherein the main braking part further includes a knuckle in which the main pads are installed to be movable forward and backward to be fixedly installed in a vehicle body.

13. The disc brake system of claim 11, wherein the main braking part further includes sealing members provided between the pistons and the cylinders and configured to return the pistons.

14. The disc brake system of claim 11, wherein the main actuator includes hydraulic circuits configured to provide the supplied hydraulic pressure corresponding to the input value to the cylinders.

15. The disc brake system of claim 11, wherein the main actuator includes:
an electric motor; and
a power converter configured to convert a rotational motion of the electric motor into a linear motion and provide the supplied hydraulic pressure corresponding to the input value to the cylinders.

16. The disc brake system of claim 15, wherein the power converter includes:
a spindle configured to rotate by the electric motor; and
a spindle nut provided inside each of the pistons and configured to convert a rotational motion of the spindle into a linear motion.

17. The disc brake system of claim 11, wherein the auxiliary braking part includes:
the auxiliary pad provided on the bridge; and
an auxiliary actuator configured to move the housing forward and backward in the radial direction of the disc.

18. A method of controlling a disc brake system, the disc brake system comprising:
a main braking part configured to slide and move a pair of main pads respectively disposed on both side surfaces of a disc in a direction of an axis of the disc and generate a main braking force by friction between the both side surfaces of the disc and the main pads;
an auxiliary braking part configured to slide and move an auxiliary pad disposed at a side of an outer circumferential surface of the disc in a radial direction of the disc and generate an auxiliary braking force by friction between the outer circumferential surface of the disc and the auxiliary pad; and
a controller configured to activate the main braking part in response to an input value generated based on a pedal force of a brake pedal measured by a sensor,
wherein the controller activates or deactivates the auxiliary braking part by comparing the input value and a preset threshold value.

19. The method of claim 18, wherein, based on the input value greater than or equal to the threshold value, the controller activates the auxiliary braking part and then activates the main braking part.

20. The method of claim 18, wherein, based on the input value less than the threshold value, the controller maintains deactivation of the auxiliary braking part and activates the main braking part.
